(19) United States
(12) Patent Application Publication
(10) Pub. No.: US 2018/0237162 A1
(43) Pub. Date: Aug. 23, 2018

(54) METHOD OF DESIGNING A WINGLET AND A WINGLET DESIGNED THEREBY

(71) Applicants: AIRBUS OPERATIONS LIMITED, Bristol (GB); AIRBUS OPERATIONS GMBH, Hamburg (DE)

(72) Inventors: Christopher WRIGHT, Bristol (GB); Ben COMMIS, Bristol (GB); Kasidit LEOVIRIYAKIT, Bristol (GB); Gerd HELLER, Hamburg (DE)

(21) Appl. No.: 15/899,788

(22) Filed: Feb. 20, 2018

(30) Foreign Application Priority Data
Feb. 22, 2017 (GB) 1702835.8

(51) Int. Cl. B64F 5/00; B64C 23/06

(52) U.S. Cl. CPC B64F 5/00; B64C 23/069

(57) ABSTRACT

A method of designing a winglet (3) for an aircraft (7) including: defining the location of the winglet root; defining a maximum height for the winglet tip; defining a maximum span for the winglet; creating the winglet shape by locating the winglet root (13′), locating the winglet tip (15′) at the location of maximum height and maximum span, and connecting the winglet root (13′) to the winglet tip (15′) using a winglet shape. The winglet shape includes a curved transition region (17′) extending away from the root, and a wing-like region extending from the distal end of the transition region (17′) to the winglet tip (15′). The step of creating the winglet shape includes iteratively changing the curvature and/or the location of the center of the curvature of the transition region, whilst maintaining the locations of the winglet root and winglet tip.

The present disclosure relates to winglets for aircraft, to a method of designing a winglet, a method of manufacturing a winglet, and a winglet designed and/or manufactured using such methods.

### BACKGROUND OF THE INVENTION

Winglets are well-known and can take a number of forms. Examples of winglets are shown in U.S. Pat. No. 5,348,253, U.S. Pat. No. 6,484,968, WO 2008/061739, WO 2008/155566, WO 2012/007358, U.S. Pat. No. 5,275,358, and WO 2012/171023. Generally speaking, winglets seek to reduce induced drag by increasing the effective span of the aircraft to which they are fitted.

There tends to be a limit to the maximum feasible size of a winglet, especially its height, due to structural limits on the wing (for example the strength of the wing root). The maximum aircraft span is also limited. The span is effectively limited (for a given ICAO Annex 14 aerodrome code letter) by airport operating rules which govern various clearances required when manoeuvring around the airport (such as the span and/or ground clearance required for gate entry and safe taxiway usage).

For some high-span aircraft, designers have considered moving away from using fixed winglets, and have instead focussed on providing a moveable wing tip device which is moveable between a flight configuration (beyond the allowance gate limit span) and a ground configuration (in which ground configuration the wing tip device is moved away from the flight configuration such that the span of the aircraft is reduced to within the gate limit). Examples, of such moveable wing tip devices can be found in WO2015150835 or WO2015162399. Nonetheless, there is also still a desire to provide a fixed wing tip device that is suitable for use on a high-span aircraft. An example of a fixed wing tip device for use on a high-span aircraft is shown in WO 2012/007358. In this arrangement, the upper wing-like element of the wing tip device meets a span limit when the aircraft is on the ground, and under 1-g flight loading a lower wing-like element is arranged to offset some of the span decrease as the wing is aero-elastically deformed, and the upper wing-like element moves inboard. US 2013/0256460 discloses another arrangement having fixed upper and lower winglets, but one in which the lower winglet is arranged to increase the overall span under 1-g flight loading.

It will be appreciated from the above that when facing size constraints imposed on span and/or height, the design of wing tip devices has tended to focus either on providing a moveable wing tip device, or on providing devices with both upper and lower winglets.

Aspects of the present invention seek to provide an improved wing tip device, especially when facing constraints on span and/or height.

### SUMMARY OF THE INVENTION

According to a first aspect of the invention, there is provided a method of designing a winglet for an aircraft, the method comprising the steps of: defining the location of the winglet root; defining a maximum height for the winglet tip; defining a maximum span for the winglet; creating the winglet shape by locating the winglet root at the location of the winglet root, locating the winglet tip at the location of maximum height and maximum span, and connecting the winglet root to the winglet tip using a winglet shape; wherein the winglet shape comprises a curved transition region extending away from the root, and a wing-like region extending from the distal end of the transition region to the winglet tip, and wherein the step of creating the winglet shape comprises iteratively changing the curvature and/or the location of the centre of the curvature of the transition region, whilst maintaining the locations of the winglet root and winglet tip, such that the total length of the winglet from root to tip is increased whilst keeping the winglet within the maximum height and span constraints.

The first aspect of the invention recognises that, once the height, span and root limitations for a winglet have been set, the total length of the winglet can be increased by adjusting the shape of the transition region. More specifically, the total length can be increased by adjusting the curvature, and/or the location of the centre of the curvature, of the transition region. By increasing the total length of the winglet (i.e. the unrolled length from root to tip) the winglet becomes more effectual at reducing induced drag because the effective length of the wing is increased.

The total length of the winglet may be optimised to minimise the overall drag coefficient of the wingtip. For example, the shape of the transition section may be iteratively adjusted to optimise the balance between a reduction in induced drag and an increase in friction drag (caused by the greater wetted area of the longer winglet).

The maximum height for the winglet tip may be a parameter set by structural considerations. For example the maximum wing root bending moment. The method of the first aspect of the present invention is thus especially beneficial when the winglet is being designed to meet competing design requirements (for example a balance between aerodynamic and structural requirements).

The maximum span for the winglet may be a parameter set by an airport compatibility limit (for example relating to clearance restrictions for buildings, signs, other aircraft). The compatibility limit is preferably a gate limit.

The step of creating the winglet shape comprises iteratively changing the curvature and/or the location of the centre of the curvature of the transition region. The location of the centre of curvature of the transition region may be changed by progressively moving that centre of curvature outboard. This has been found to be beneficial because it ‘pushes’ the curve of the transition region outboard which, when the root and tip locations are fixed, increases the length between these end points and hence the length of the winglet. The curvature may be the local curvature at points along the length of the transition region. The changing of the curvature may comprise changing the magnitude of the curvature. The changing of the curvature may comprise smoothing the curvature between the proximal and distal ends of the transition region. The changing of the curvature may comprise increasing the radius curvature of that region. This has been found to be beneficial because it creates a relatively open junction between the wing and the wing-like element. This type of open junction tends to be beneficial both in terms of structural considerations and aerodynamic considerations in reducing interference drag. In some embodiments of the invention, the step of creating the winglet shape comprises iteratively changing both the curvature and the location of the centre of the curvature of the transition region.

It will be appreciated that reference herein to a centre and/or radius of curvature does not necessarily imply the transition section is of constant radius. The curvature may be local curvature. In some embodiments, the transition region is a curve having a varying local radius of curvature. The radius of curvature of the transition section may initially decrease from its proximal end (at which it meets the winglet root) to a minimum radius of curvature, and then increase towards the distal end of the transition section. The proximal and distal ends of the transition section preferably blend into the adjacent regions of the wing/winglet (for example they may meet them substantially tangentially). In embodiments in which the magnitude of the curvature of the transition region is changed, this may be effected by changing (preferably increasing) the minimum radius of curvature. In embodiments of the invention in which the location of the centre of the curvature of the transition region is changed, this may be effected by changing the location of the centre of the arc for the minimum radius of curvature. It will be appreciated that when changes to the minimum radius of curvature are made, corresponding changes may be made to the curvature either side of that location to ensure a blended transition from the wing to the wing-like region. Furthermore, the present invention is not limited to arrangements in which the centre of curvature is changed directly; it also encompasses arrangements in which the centre of curvature is moved as a result of an alteration of the shape of the transition section per se.

The wing-like region may be substantially planar. The planar wing-like region may extend substantially vertically downward from the winglet tip. In the context of a fixed tip height and span, such an arrangement has been found to be beneficial because it tends to facilitate a large overall length of winglet (the transition region necessarily being pushed outboard relative to an arrangement having an outwardly canted planar region). The wing-like region need not necessarily be exactly planar. For example, the wing-like region may be part of a conic section that has a sufficiently high radius that it can be considered as substantially planar.

The maximum height and span of the winglet may be defined for when an aircraft, having the winglet fitted, is under worst-case static loading. The worst-case static loading will be readily understood by the skilled person. It is typically the highest static loading the aircraft wing would be expected to encounter during normal use (for example when the aircraft is stationary on the ground, and fully fuelled).

To date, winglet design has typically been carried out with reference to a ‘jig shape’ (i.e. the shape and orientation of the winglet when it is manufactured and under no load). Aspects of the present invention recognise that by designing to a ‘ground shape’, the shape of the winglet may be more effectively optimised, especially when there are height and span restrictions.

In embodiments in which the winglet comprises a wing-like substantially planar region, the winglet may be designed such that the wing-like region is vertical when the aircraft is stationary on the ground under the worse-case static loading. When the aircraft is in flight under 1-g flight conditions the wing-like region may be canted inboard such that the winglet tip is moved inboard of the point of maximum span of the winglet. The different orientation of the winglet may result from aero-elastic deformation of the wing and winglet under the 1-g flight loading.

The method of designing may comprise the steps of analysing a chosen design against performance criteria (for example lift/drag performance). The method may comprise the steps of choosing a final design based on the outcome of that analysis. This many enable the optimum design to be selected (for example where the extra length of wingtip has created its maximum benefit in reducing induced drag compared with the increase in friction drag from the extra wetted area).

It will be appreciated that the process of designing the winglet described herein is part of a wider design process in which there are other design constraints influencing the shape. Thus, the final design is not purely governed by the design process described herein, and the design process does not necessarily optimise the shape exclusively to increase the length—the process may, however, enable that parameter to be optimised in the context of other competing parameters in the overall design process (i.e. the winglet may be optimised for the overall intended goal).

According to a second aspect of the invention, there is provided a method of manufacturing a winglet comprising the steps of: designing a winglet using the method of the first aspect, and manufacturing the winglet to that design.

According to another aspect of the invention, there is provided a winglet designed using the method of the first aspect.

According to yet another aspect of the invention, there is provided a winglet manufactured using the method of the second aspect.

According to yet another aspect of the invention, there is provided a winglet comprising: a winglet root, a curved transition region extending from the root to a distal end, and a wing-like region extending from the distal end of the transition region to a winglet tip; wherein the shape of the winglet has been formed by fixing the location of the winglet tip at a maximum height and a maximum span whilst moving the location of the centre of the curvature of the transition region outboard such that the length of the winglet from root to tip is increased, whilst keeping the winglet within the maximum height and span constraints. By fixing the location of the winglet tip at a maximum height and a maximum span whilst moving the location of the centre of the curvature of the transition region outboard, the length of the winglet from root to tip may be increased, and preferably maximised, whilst keeping the winglet within the maximum height and span constraints. By increasing the total length of the winglet (i.e. the unrolled length from root to tip), the winglet becomes more effectual at reducing induced drag because the effective length of the wing is increased.

The aircraft is preferably a passenger aircraft. The passenger aircraft preferably comprises a passenger cabin comprising a plurality of rows and columns of seat units for accommodating a multiplicity of passengers. The aircraft may have a capacity of at least 20, more preferably at least 50 passengers, and more preferably more than 50 passengers. The aircraft is preferably a powered aircraft. The aircraft preferably comprises an engine for propelling the aircraft. The aircraft may comprise wing-mounted, and preferably underwing, engines.

According to yet another aspect of the invention, there is provided a winglet for use as the winglet in the above-mentioned aspect relating to an aircraft.

It will be appreciated that, unless otherwise specified, the shape of the winglet referred to herein refers to the shape in a frontal projection (i.e. on to a y-z plane). The shape of the winglet may be defined by the ¼ chord line running along the winglet.

It will of course be appreciated that features described in relation to one aspect of the present invention may be incorporated into other aspects of the present invention. For example, the method of the invention may incorporate any of the features described with reference to the apparatus of the invention and vice versa.

### DESCRIPTION OF THE DRAWINGS

Embodiments of the present invention will now be described by way of example only with reference to the accompanying schematic drawings of which:

FIG. 1 shows a frontal view of an initial and a final iteration of a winglet design, created using a method according a first embodiment of the invention;

FIG. 2 is a flowchart showing steps of the method of the first embodiment;

FIG. 3 is an aircraft incorporating the final iteration of the winglet of FIG. 1;

FIG. 4 is a frontal view showing the winglet design in FIG. 1 but in ground, jig and 1-g flight shapes.

### DETAILED DESCRIPTION

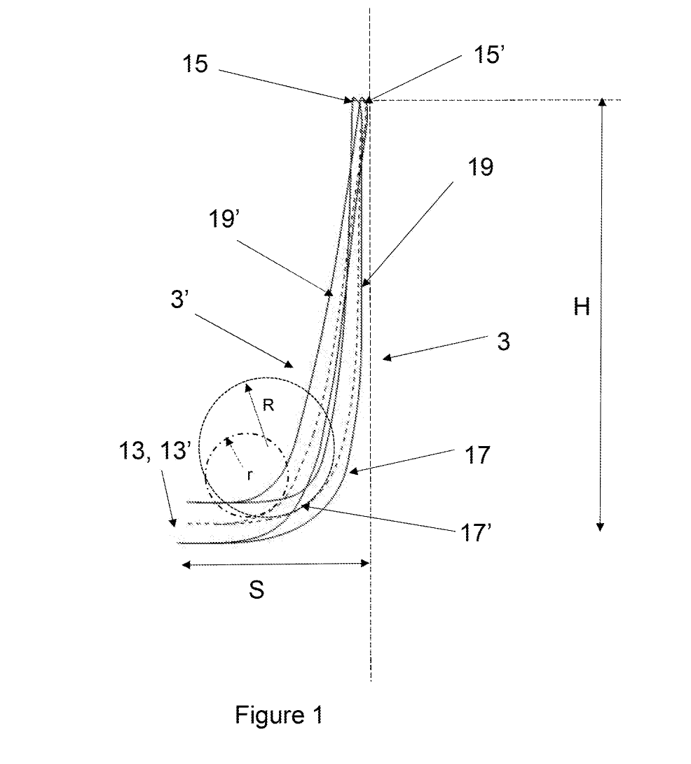

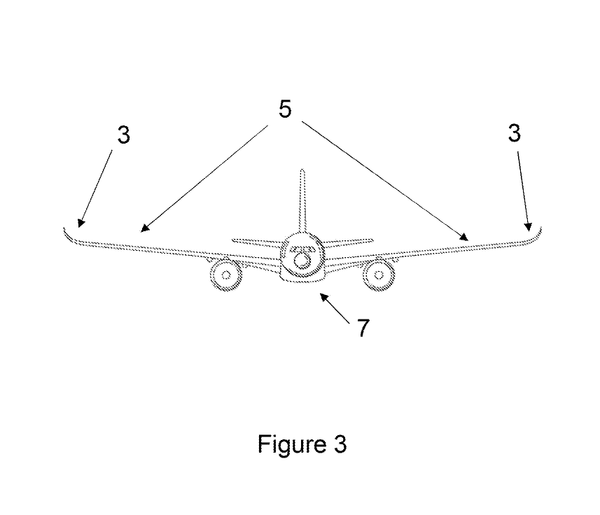

FIG. 1 shows a frontal view of an initial and a final iteration of a winglet design, created using a method according a first embodiment of the invention. The winglet 3 is for mounting on the end of the wings 5 of an aircraft 7 (the aircraft, wing and the final iteration of the winglet are shown schematically in FIG. 3).

FIG. 1 shows an initial iteration of the winglet 3′ on the left-hand side, and the final iteration of the winglet 3 on the right-hand side. Features of the initial iteration share common reference numerals with the final iteration but with the suffix ‘.

The initial shape of the winglet 3′ is determined by three criteria:

Firstly, the location of the winglet root 13′. This is the location at which the winglet is to structurally join the end of the wing 5, and also at which the shape of the winglet 3′ begins to transition away from the generally planar wing.

Secondly, the height H of the tip 15′ of the winglet 3′. This is determined by structural considerations (for example bending moments generated in the wing or at the winglet root, during use). Based on this structural information, a maximum height constraint H is placed on the tip 15′ of the winglet 3′.

Thirdly, the span S of the winglet 3′. This is determined by compatibility limits at airports, typically the compatibility gate limit. The maximum span S of the winglet is set by considering the total span of the aircraft (with the winglet is fitted) with the aircraft stationary on the ground and with a full fuel load (i.e. the worst-case static load).

Within these criteria, the first stage of the design process was to create the shape of initial winglet 3′ shown on the left-hand side of FIG. 1. This winglet 3′ comprises a curved transition region 17′ extending from the winglet root 13′ and a substantially planar wing-like region 19′ extending from the distal end of the transition region 17′ to the tip 15′. This initial winglet design 9′ broadly possesses some of the general characteristics seen in known winglet designs, such as the upper winglet of WO2008/061739 (i.e. a curved transition and an outwardly canted planar region)

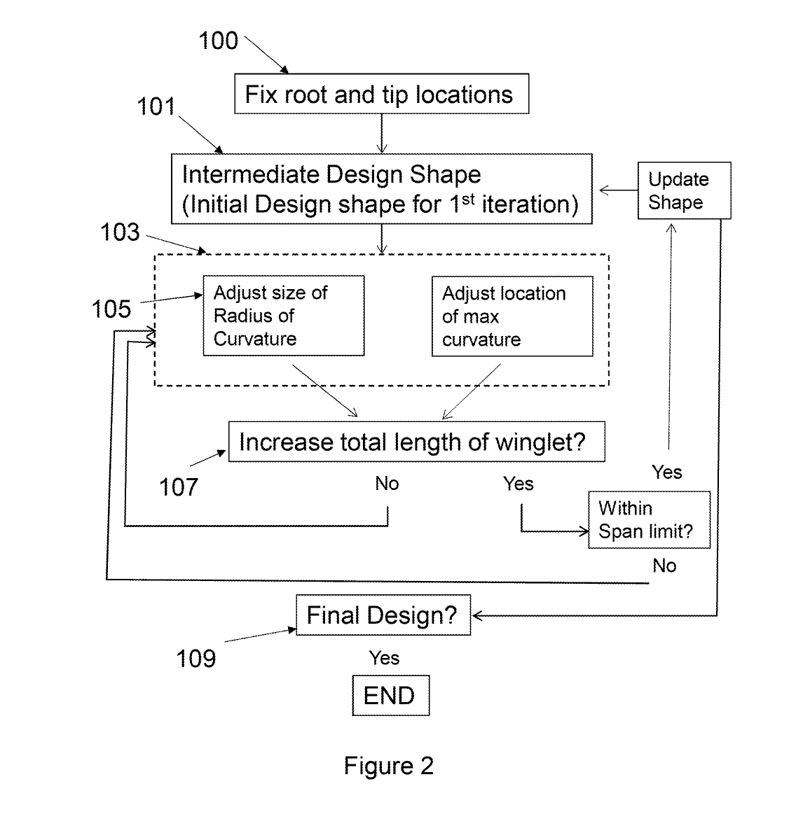

Whilst such a winglet may already exhibit favourable performance, the present invention has recognised that its performance may be further improved, whilst keeping within the tight constraints of span and height discussed above. That process will now be described with reference to FIGS. 1 and 2:

FIG. 2 is a flowchart showing the design process by which the winglet design is developed to the final design shown on the right-hand side of FIG. 1. The starting point is the initial design with the root and tip locations held fixed and the span constraint is applied 100, 101. The shape of the winglet is then adjusted such that the centre of curvature (at the location of maximum curvature of the transition region) is moved a short distance outwardly 103. The radius of curvature at this location is adjusted (typically increased) 105 to maintain an open junction and the shape of the transition region either side is adjusted to maintain a smooth blend into the wing-like region.

The present invention recognises that such adjustments of the design tend to increase the overall length of the winglet (i.e. the un-rolled length) from root to tip. This increases the effective length of the winglet and thereby results in improved induced drag performance. After the initial adjustment of the shape, the design typically goes through several iterative loops: i.e. if the length of the winglet has been increased by the adjustments 107, the span constraint is re-checked 109 and, assuming that constraint is met, the loop is repeated to see if the shape can be further adjusted.

Broadly speaking, this process results in the centre of curvature of the transition region being pushed outwards, and the radius of curvature being increased, until the wing-like region extends vertically downwardly from the tip and along the span constraint S. The wing like region will not, of course, be pushed out beyond that, because it would exceed the span constraint S. It will be appreciated that the process herein is part of a wider design process in which there are also other design constraints influencing the shape. Thus, the final design is not purely governed by the design process described herein, and the design process does not necessarily optimise the shape exclusively to increase the length with the exclusion of all other factors. The process does, however, enable that length to be optimised in the context of other competing parameters in the overall design process.

In the first embodiment of the invention, the final design created using such a process is shown on the right-hand side of FIG. 1: the planar wing-like region 19 extends vertically downwardly from the tip 15 along the span limit S. The transition region 17 then smoothly blends the wing-like region 19 into the root 13 at which it is joined to the wing 5. The transition region extends (from the bottom of the planar region 19) through a curve having an initially decreasing radius of curvature, to a minimum radius of curvature R, back to an increasing radius of curvature to blend with the end of the wing. As shown in FIG. 1, the minimum radius R is larger on the final design than the radius r on the initial design, and the centre of that curvature has moved outboard.

Due to the thickness of the winglet, and the change in the cant angle towards the tip, it will be appreciated that the upper-most edge of the winglet tip is moved inboard very slightly in the final design compared to the first design, to ensure it does not exceed the overall span constraint S. However, the skilled person will understand that in the context of the present invention, such a movement is negligible and the location of the tip is deemed to be fixed during the design process.

The shape of the winglet referred to herein refers to the shape in a frontal projection (i.e. on to a y-z plane) as shown in FIG. 1. The shape of the winglet may be defined by any appropriate datum line through the winglet, such as the ½ chord or the ¼ chord line running along the winglet. In the first embodiment, the shape is defined by the ½ chord line.

In the first embodiment of the invention, the winglet 3 is designed in its ground shape under worst-case static loading (referred to below as the ‘ground shape’). The winglet 3 is designed such that, in the ground shape, the wing-like region 19 extends vertically along the span-limit S. However, under 1-g flight conditions, the aero-elastic deformation of the wing 5 and winglet 3 are such that the wing-like region 19 becomes inwardly canted such that the winglet tip 15 is located inboard of the location of maximum span. That location of maximum span is shifted towards the distal end of the transition region, but is no longer against the span limit S.

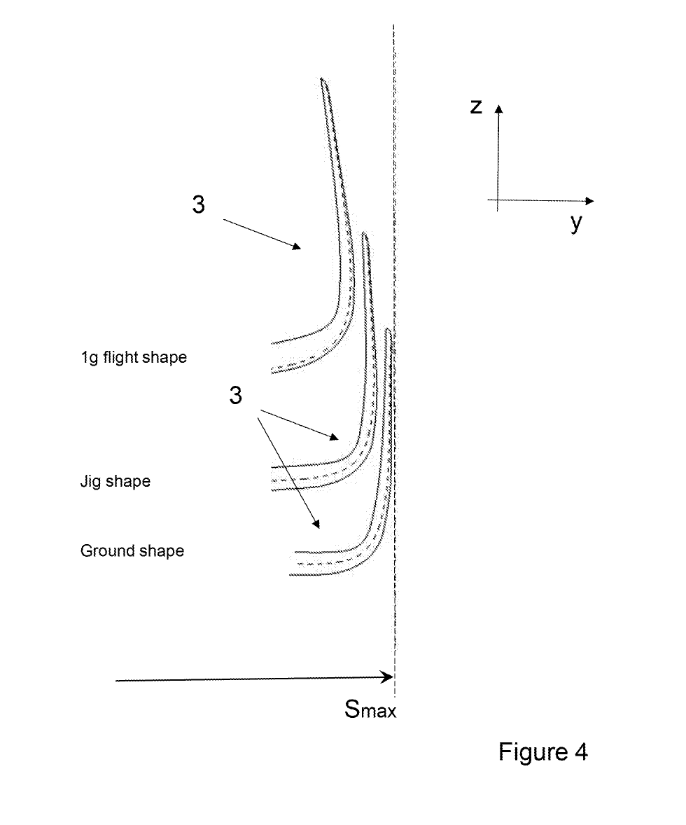

FIG. 4 shows three images of the winglet 3, in the ground shape (lowest image), the ‘jig shape’ (middle images) and the 1-g flight shape (upper image) demonstrating this behaviour.

Whilst the present invention has been described and illustrated with reference to particular embodiments, it will be appreciated by those of ordinary skill in the art that the invention lends itself to many different variations not specifically illustrated herein. By way of example, the wing tip device may include a downwardly extending winglet; the number of iterative steps in the design process may be different to that shown here.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

1. A method of designing a winglet for an aircraft, the method comprising the steps of:
i. defining the location of a root for the winglet;
ii. defining a maximum height of a tip for the winglet;
iii. defining a maximum span for the winglet;
iv. creating a winglet shape by locating a winglet root at the location of the root, locating a winglet tip at a location no higher than the maximum height, and defining a span of the winglet shape which is no greater than the maximum span, and connecting the winglet root to the winglet tip using the winglet shape;
wherein the winglet shape comprises a curved transition region extending away from the winglet root, and a wing-like region extending from a distal end of the curved transition region to the winglet tip, and
wherein the step of creating the winglet shape comprises iteratively changing a curvature and/or location of a center of curvature of the curved transition region, while maintaining the location of the winglet root and maintaining the location of the winglet tip, such that a total length of the winglet shape from the winglet root to the winglet tip is increased while keeping the winglet shape in compliance with the maximum height and the maximum span.

2. The method according to claim 1, wherein the total length of the winglet is optimized to minimize an overall drag coefficient of the wing tip of the winglet shape.

3. The method according to claim 1, wherein the location of the center of curvature of the transition region is changed by progressively moving that center of curvature outboard.

4. The method according to claim 1, wherein the changing of the curvature of the transition region comprises increasing a radius curvature of the curvature of the transition region.

5. The method according to claim 1, wherein the wing-like region is substantially planar.

6. The method according to claim 5, wherein the wing-like region extends vertically downward from the winglet tip.

7. The method according to claim 1, wherein the maximum height and span of the winglet are defined for when an aircraft, having the winglet fitted, is stationary on the ground.

8. The method according to claim 7, wherein the winglet is designed such that the wing-like region is substantially vertical when the aircraft is stationary on the ground under worst-case static loading, and when the aircraft is in flight under 1-g flight conditions the wing-like region is designed to be canted inboard such that the winglet tip is moved inboard of the point of maximum span of the winglet.

9. A method of manufacturing a winglet comprising the steps of:
designing a winglet using the method according to claim 1; and
manufacturing the winglet to conform to the design of the winglet.

10. A winglet designed using the method of claim 1.

11. A winglet manufactured using the method of claim 9.

12. A winglet comprising: a winglet root, a curved transition region extending from the root to a distal end, and a wing-like region extending from the distal end of the transition region to a winglet tip;
wherein the winglet has a shape formed by fixing a location of the winglet tip at a maximum height and a maximum span whilst moving the location of the center of the curvature of the transition region outboard such that the length of the winglet from root to tip is increased, whilst keeping the winglet within the maximum height and span constraints.

13. A method to design a winglet shape for an aircraft, wherein the winglet shape includes a root, a tip, a curved transition region extending from the root towards the tip, and a wing-like region extending from the curved transition region to the tip, wherein the method comprises:
defining a location for the root of the winglet shape;
defining a maximum height of the tip of the winglet shape;
defining a maximum span of the winglet shape;
iteratively changing a curvature and/or location of a center of curvature of the curved transition region, wherein the iterative changes progressively increase a total length of the winglet shape and do not change the location of the root, and
during and/or after the iterative changes, conforming that the winglet shape complies with the maximum height and the maximum span.

14. The method of claim 13 wherein the step of iteratively changing includes progressively moving the center of the curvature away from the root.

15. The method of claim 13 wherein the step of iteratively changing includes progressively increasing a radius of the curvature.

16. The method of claim 13 wherein the step of iteratively changing includes maintaining the wing-like region parallel to a plane.

17. The method of claim 13 wherein the steps of defining the maximum height and the maximum span incorporate an assumption that the aircraft is on the ground and the winglet shape corresponds to a winglet mounted to a wing of the aircraft.

18. The method of claim 13 wherein the step of iteratively changing includes maintaining the wing-parallel to a vertical plane.
